(19) United States
(12) Patent Application Publication
(10) Pub. No.: US 2009/0133761 A1
(43) Pub. Date: May 28, 2009

(54) Control valve unit with alternating stop

(75) Inventors: Grit Geissler, Dresden (DE); Horst Stegmaier, Ulm (DE)

Correspondence Address: SCULLY SCOTT MURPHY & PRESSER, PC, 400 GARDEN CITY PLAZA, SUITE 300, GARDEN CITY, NY, 11530, US

(73) Assignee: BRUENINGHAUS HYDROMATIK GMBH, ELCHINGEN (DE)

(21) Appl. No.: 11/921,125

(22) PCT Filed: Aug. 4, 2006
(86) PCT No.: PCT/EP2006/007742

§ 371 Date: Nov. 27, 2007

(30) Foreign Application Priority Data
Aug. 9, 2005 (DE) 10 2005 037 619.3

(51) Int. Cl. F16K 17/00

(52) U.S. Cl. 137/512.5

(57) ABSTRACT

The invention relates to a control valve unit (9) for a variation device of a hydrostatic piston engine. The control valve unit (9) comprises a valve housing (34), in which a valve element is disposed in a longitudinally displaceable manner. The valve element is adjustable from a neutral position in the direction of a first end position and an oppositely directed second end position. With increasing adjustment of the valve element a first or a second output port (35a, 35b) is increasingly connected to an input port (12). The respective other output port (35b, 35a) is at the same time increasingly connected to a relief line (13). The valve element comprises a first valve piston (32a) and a second valve piston (32b), which act upon one another via an elastic element (27).

The invention relates to a control valve unit for a variation device of a hydrostatic piston engine.

For varying the volumetric displacement of a hydrostatic piston engine it is often necessary to set in a variation apparatus two actuating pressures, which act in opposite directions upon an adjusting piston. From DE 195 40 654 C1, for this purpose, a control valve is known, in which a valve piston is disposed as a valve element in a longitudinally displaceable manner in a valve housing. The valve piston is loadable at its oppositely oriented end faces in each case with a force. By means of an axial movement of the valve piston in one direction, an input pressure port is connected to a first output. At the same time, a second output is connected to a tank port. Upon a movement in the opposite direction, the second output port is connected to the input port and at the same time the first output port is connected to the tank port. In this way, the two actuating pressure chambers acting in opposite directions and connected in each case to an output port may be set to a differential force of adjustable direction and magnitude. The resulting actuating movement of the actuating piston is mechanically coupled back as a feedback force by a feedback element to the valve piston. The actuating movement is transmitted by the feedback element and deflects one of two limbs. The two limbs are connected to one another by a spring, wherein the respective non-deflected limb is supported against a driving pin of the valve piston. In this way, by tensioning of the spring connecting the two limbs the actuating movement is transmitted to the valve piston in such a manner that the resulting force counteracts the deflection of the valve piston.

The described variation device has the drawback that a considerable mechanical outlay is required. Because of the one-piece valve piston, it is moreover necessary to introduce in the valve housing a very precisely constructed bore for receiving the valve piston. At the same time, the one-piece construction of the valve piston is necessary in order given an adjustment of the actuating piston in both directions to be able to summon up in each case a counter-force for the feedback element. Furthermore, considerable standards of accuracy are required of the axial position of the individual control edges because in each case a coupled movement of the two control edges associated with the different actuating pressure chambers occurs.

The underlying object of the invention is to provide a control valve unit for a hydrostatic piston engine that is operationally reliable and easy to manufacture.

The object is achieved by the control valve unit according to the invention having the features of claim 1.

According to claim 1, the control valve unit according to the invention comprises a valve housing having a valve element disposed in a longitudinally displaceable manner therein. The valve element is adjustable from a neutral position in both directions so that a first or a second output port is increasingly connectable to an input port. Simultaneously with the increasing connection of the first or the second output port to the input port, the respective other output port is increasingly connected to a tank volume. According to the invention, in the control valve unit the valve element is composed of a first valve piston and a second valve piston, wherein the two valve pistons act upon one another via an elastic element. It is therefore possible to achieve a coupled adjustment of the entire valve element without any need for a rigid connection of the positions of the respective control edges. In particular, it is possible to bring one of the valve pistons into a position, in which its output port is connected by a large throughflow area to the tank port. At the same time, by virtue of the elastic element the other valve piston remains adjustable in any desired manner. The elastic element therefore allows the relative movement of the two valve pistons relative to one another, wherein however a coupling of the two valve pistons to one another is maintained.

By virtue of the elastic coupling of the first valve piston and the second valve piston it is moreover possible to influence the control response by means of the axial forces acting upon the respective valve pistons. Thus, for example, it is possible to exert an increasing force upon the one valve piston. This force is transmitted to the second valve piston, which is for example likewise loaded with an oppositely directed axial force. While the first valve piston is already being adjusted, at the second valve piston the axial force may gradually be successively reduced. By such a controlled loading of the two valve pistons with in each case a separate actuating force it is possible, for example, for an actuating piston to be hydraulically clamped at all times in an advantageous manner. For this purpose, the elastic element is compressed so that the opening at a control edge of one valve piston may be realized independently of the opening at a control edge of the other valve piston.

Advantageous developments of the control valve unit according to the invention are outlined in the sub-claims.

In particular, it is advantageous to provide for control purposes a hydraulic force, which acts upon an end face of each valve piston and is generated by the pressure effective at the respective output port. In this case, it is further advantageous to allow the hydraulic force to be applied to an end face of the valve piston that is formed on an extension of reduced diameter. This occurs in a particularly advantageous manner by means of a sleeve, into which the two extensions of the valve pistons engage. The sleeve has for each extension a separate control pressure chamber, in which the pressure of the appropriate output port acts upon the end face of the extension. It is particularly advantageous to dispose the sleeve in a longitudinally displaceable manner on the two extensions and hence enable a relative movement between the extensions and the sleeve.

The supply of the pressure prevailing in each case at the output port is effected preferably through pressure medium channels formed in the respective valve pistons.

It is particularly preferred when the two valve pistons are constructed with an identical geometry and disposed in opposite directions to one another in the valve housing.

A preferred embodiment of the control valve unit according to the invention is illustrated in the drawings and explained in detail in the following description. The drawings show:

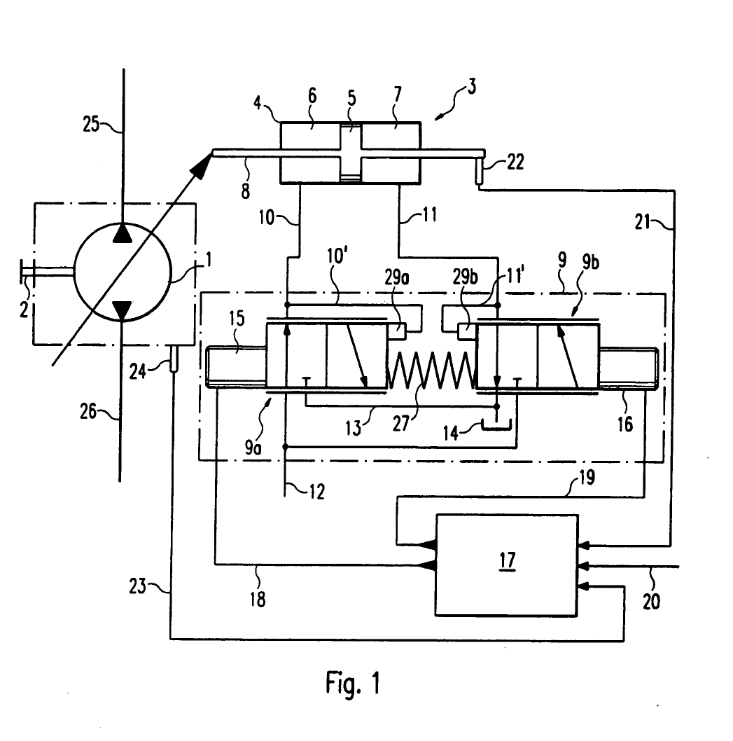

FIG. 1 a diagrammatic representation of a variation device for a hydrostatic piston engine;

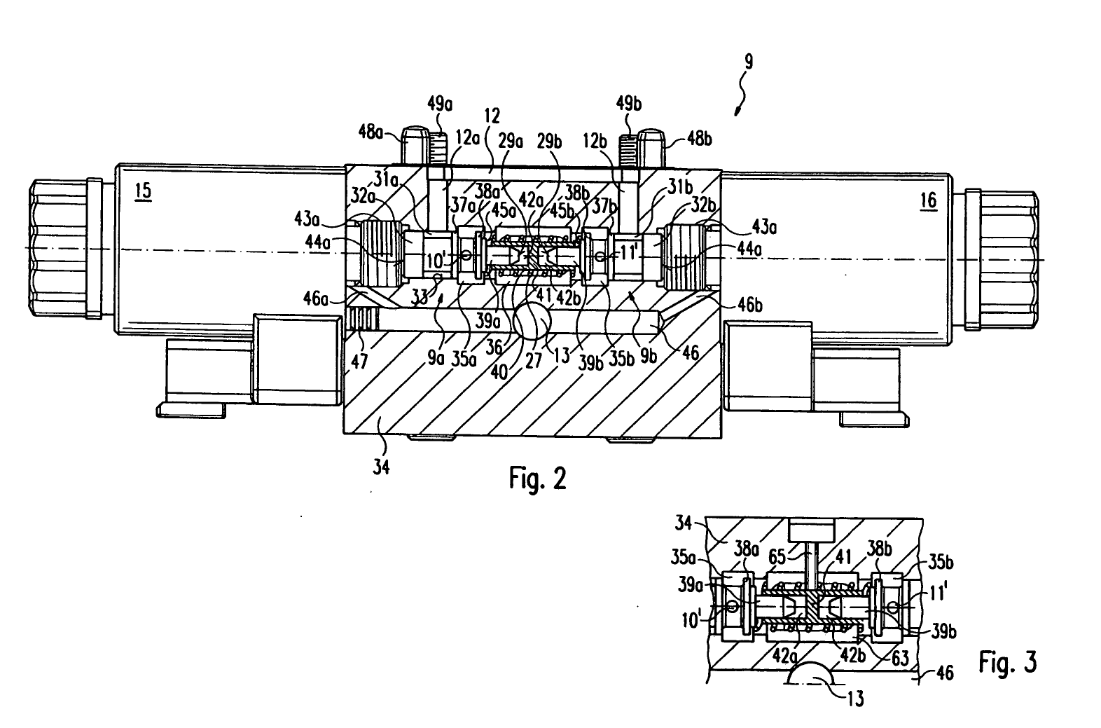

FIG. 2 a first partial section through a control valve unit according to the invention;

FIG. 3 an enlarged representation of a detail of the hydrostatic piston engine of FIG. 2 with a fixed sleeve;

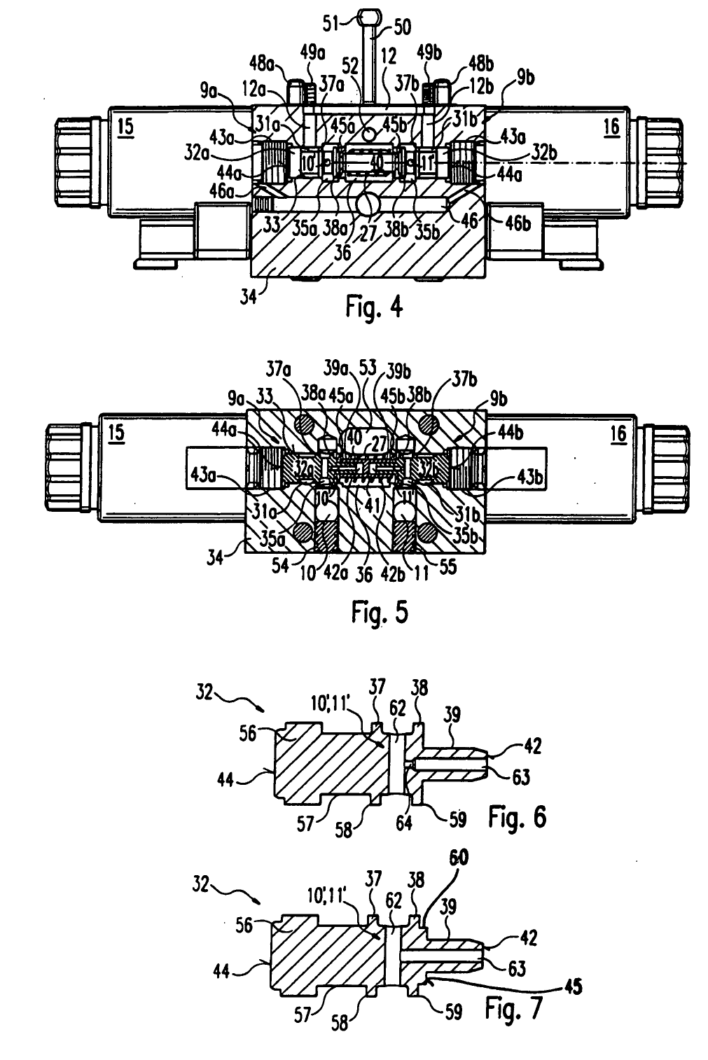

FIG. 4 a second partial section through a control valve unit according to the invention;

FIG. 5 a third partial section through a control valve unit according to the invention;

FIG. 6 a first embodiment of a valve piston of the control valve unit according to the invention; and

FIG. 7 a second embodiment of a valve piston of the control valve unit according to the invention.

To make it easier to understand the control valve unit according to the invention, FIG. 1 shows a diagrammatic representation of a variation device of a hydrostatic piston engine is shown. The hydrostatic piston engine in FIG. 1 takes the form of a variable displacement hydraulic pump 1, which is connected by a driving shaft 2 to a non-illustrated drive motor. The hydraulic pump 1 is provided for delivery into a first working line 25 or a second working line 26. The control valve unit according to the invention may equally be used in a piston engine in the form of a hydraulic motor.

For varying the volumetric displacement of the hydraulic pump 1, a variation device 3 is provided. The variation device 3 comprises a double-acting cylinder 4, in which an actuating piston 5 is disposed. The actuating piston 5 divides the cylinder 4 into a first actuating pressure chamber 6 and a second actuating pressure chamber 7, wherein the actuating piston 5 is loadable in both actuating pressure chambers 6, 7 with a hydraulic force. Via a piston rod 8 the actuating movement of the actuating piston 5 is transmitted to a variation mechanism of the hydraulic pump 1.

For setting the actuating pressure that is effective in the first actuating pressure chamber 6 and/or the second actuating pressure chamber 7, a control valve unit 9 is provided. The control valve unit 9 is connected by a first actuating pressure line 10 and a second actuating pressure line 11 to the first actuating pressure chamber 6 and the second actuating pressure chamber 7 respectively. By means of the control valve unit 9 the first actuating pressure line 10 and the second actuating pressure line 11 are connectable in each case to a supply pressure channel 12 or a relief line 13.

Thus, for example, in a first end position of a valve element of the control valve unit 9 the first actuating pressure line 10 is connected to the supply pressure channel 12, while the second actuating pressure line 11 is relieved via the relief line 13 into the tank volume 14.

The force for adjusting the control valve unit 9 in the direction of the first end position illustrated in FIG. 1 is generated by means of a first proportional magnet 15, which exerts an axial force on the valve element of the control valve unit 9. During the loading of the first actuating pressure chamber 6 with the supply pressure and simultaneous relief of the second actuating pressure chamber 7, the actuating piston 5 executes a movement to the right in FIG. 1.

In order to realize a movement in the opposite direction, a second proportional magnet 16 oriented in the opposite direction to the first proportional magnet 15 receives an actuating signal. As a result of the increasing force by means of the second proportional magnet 16, the valve element of the control valve unit 9 is adjusted in the direction of a second end position, so that increasingly the second actuating pressure line 11 is connected to the supply pressure channel 12 and the first actuating pressure line 10 is connected to the relief line 13. Consequently, the pressure gradient between the first actuating pressure chamber 6 and the second actuating pressure chamber 7 is reversed, and the actuating piston 5 is deflected in the opposite direction, in the illustrated embodiment to the left.

The actuating signals for the proportional magnets 15, 16 are determined by an electronic control unit 17. For this purpose, the electronic control unit 17 is connected by a first control line 18 and a second control line 19 to the first proportional magnet 15 and the second proportional magnet 16. As input variables for the electronic control unit 17, a driving lever selection that is communicated via a signal input line 20 to the electronic control unit 17 is used for example. In addition, for determining the pivoting angle of the hydraulic pump 1 that is to be set, the position of the actuating piston 5 is acquired. For this purpose, there is disposed on the piston rod 8 of the actuating piston 5 a position measuring device 22, the signal of which is communicated via a first signal line 21 to the electronic control unit 17. It is moreover possible for example to provide on the hydraulic pump unit a temperature sensor 24, which communicates a measured temperature in the form of an electrical signal via a second signal line 23 to the electronic control unit 17.

Instead of the proportional magnets 15, 16, other means of generating the actuating forces may be provided. For example, hydraulic forces may act upon end faces of the valve element, these preferably being defined by actuating pressures that are settable by a pilot valve.

In FIG. 1 the division according to the invention of the control valve unit 9 into a first pressure reduction valve 9a and a second pressure reduction valve 9b is shown. The pressure reduction valves have in each case an output port and an input port. In this case, the common input port in the illustrated embodiment corresponds to the supply pressure channel 12, and the first and the second output port correspond to the first and the second actuating pressure line 10 and 11 respectively. The output ports of the pressure reduction valves 9a, 9b are also referred to as the discharge side. Each pressure reduction valve 9a, 9b is infinitely adjustable between a first end position and a second end position. In the first end position the input port is connected to the respective output port. In the second end position, on the other hand, the respective output port is connected to the common relief line 13.

The two pressure reduction valves 9a and 9b are coupled to one another by a spring 27, so that thrust forces may be transmitted between the valve pistons of the pressure reduction valves 9a, 9b. Instead of the spring 27, another elastic element may be used to couple the two pressure reduction valves 9a and 9b. In FIG. 1 a first end position of the control valve unit 9 is illustrated. In this first end position, by means of the first pressure reduction valve 9a the supply pressure channel 12 is connected to the first actuating pressure line 10. For this purpose, as will be additionally explained with reference to further FIGS. 2 to 5, a valve piston of the first pressure reduction valve 9a is loaded with a force by the first proportional magnet 15 and moved in the direction of the second pressure reduction valve 9b. The valve piston is therefore adjusted in the direction of its first end position, in which it connects the supply pressure channel 12 to the first actuating pressure line 10. The pressure prevailing in the first actuating pressure line 10 is supplied through an actuating pressure channel 10′ onto a first measuring face 29a, where it acts on the valve piston in the opposite direction to the force of the proportional magnet 15.

The spring 27, which at the valve piston has a seating surface as a spring cup, is displaced by the movement of the valve piston in the direction of the second pressure reduction valve 9b and loads the valve piston there with a force. If the second pressure reduction valve 9b in the case of a non-energized proportional magnet 16 is already situated in its second end position shown in FIG. 1, then a further movement of the valve piston in the direction of this end position is not possible. The spring 27 is accordingly compressed by the movement of the valve piston of the first pressure reduction valve 9a.

At the second pressure reduction valve 9b also, a position of equilibrium is adopted by the valve piston, which arises because of the force of the spring 27, the oppositely directed force of the second proportional magnet 26 and a hydraulic force, which acts upon a second measuring face 29b of the second pressure reduction valve 9b. To generate the hydraulic force at the second measuring face 29b of the second pressure reduction valve 9b, the pressure of the second actuating pressure line 11 is fed through a second actuating pressure channel 11′ to the second measuring face 29b. In the second end position of the second pressure reduction valve 9b, the second actuating pressure line 11 is connected to the relief line 13 and hence relieves the second actuating pressure chamber 7 into the tank volume 14.

In FIG. 2 a control valve unit 9 according to the invention is represented as a partial section. The control valve unit 9 is loaded with a supply pressure via a supply pressure channel 12 as a common input port, which in the illustrated embodiment is incorporated as a groove in a side wall of the control valve unit 9. The supply pressure is fed through a first supply pressure channel portion 12a or a second supply pressure channel portion 12b to the first pressure reduction valve 9a or the second pressure reduction valve 9b. The construction and function of the two pressure reduction valves 9a, 9b is described below with reference to the first pressure reduction valve 9a, which is illustrated on the left in FIG. 2. The reference characters of the elements of the first pressure reduction valve 9a are characterized by the letter suffix “a”. To avoid unnecessary repetition, a separate description of the second, identically constructed pressure reduction valve 9b is not provided. The corresponding reference characters of the second pressure reduction valve 9b are characterized in each case by the letter suffix “b”.

In communication with the first supply pressure channel portion 12a is a first annular chamber 31a, which is formed around a portion of reduced diameter of the first valve piston 32a. The first valve piston 32a is disposed in a recess in the form of a through bore 33 of the valve housing 34 of the control valve unit 9. The second valve piston 32b is disposed in the opposite direction in the bore 33.

The bore 33 has a radially widened region that forms a second annular chamber 35a around the first valve piston 32a. A further, radially widened region of the bore 33 forms a third annular chamber 36, which in the illustrated embodiment is designed jointly for both pressure reduction valves 9a, 9b and connected in a non-illustrated manner to the relief line 13.

In axial direction the first annular chamber 31a is delimited by a first portion 37a that is formed on the first valve piston 32a. Formed on the first valve piston 32a at a distance from the first portion 37a of the first valve piston 32a is a second portion 38a. Formed on the first valve piston 32a between the two portions 37a and 38a is a further region of reduced radial extent. The distance between the control edges, which are formed on mutually remote peripheral edges of the two portions 37a, 38a, is less than the axial extent of the second annular chamber 35a. In dependence upon the axial position of the first valve piston 32a, the first portion 37a and/or the second portion 38a interact in a sealing manner with the bore 33. In the first end position of the first valve piston 32a illustrated in FIG. 2, the first portion 37a interacts in a sealing manner with the bore 33, thereby interrupting a connection between the first annular chamber 31a and the second annular chamber 35a. In contrast thereto, the second radial widening 38a is situated in the region of the second annular chamber 35a, so that a throughflow connection exists between the second annular chamber 35a and the third annular chamber 36.

The second annular chamber 35a is connected to the first actuating pressure line 10, which is not illustrated in FIG. 2. In the illustrated first end position of the first pressure reduction valve 9a, therefore, the connection between the supply pressure channel 12 and the first actuating pressure line 10 is interrupted, whilst the pressure medium may flow off from the first actuating pressure chamber 6 through the first actuating pressure line 10, the first annular chamber 35a and the third annular chamber 36 into the relief line 13 and into the tank volume 14.

At its side facing the third annular chamber 36 the first valve piston 32a has a first extension 39a. The first extension 39a is preferably of a cylindrical design, wherein the free end may have a phase, and projects a slight distance into a sleeve 40. The sleeve 40 is slipped in an identical manner over a second extension 39b of the second valve piston 32b, wherein by the extension 39a and the sleeve 40 and/or the extension 39b and the sleeve 40 the internal volume of the sleeve 40 is closed to form a first control pressure chamber 42a and a second control pressure chamber 42b respectively. For this purpose, a partition 41 is disposed in the sleeve 40.

Formed on the end face of the first extension 39a is the first measuring face 29a, upon which the pressure prevailing in the second annular chamber 35a acts via an actuating pressure channel 10′, which is only partially visible in FIG. 2. Acting therefore upon the end face of the first extension 39a is the discharge-side pressure of the first pressure reduction valve 9a. A pressure rise in the first actuating pressure chamber 6 therefore gives rise to a force that loads the first valve piston 32a counter to the actuating force generated by the first proportional magnet 15. The discharge-side pressure is therefore regulated to a value defined by the force of the first proportional magnet 15.

The first proportional magnet 15 is preferably screwed by means of a first threaded connection 43a into the valve housing 34 and acts via a tappet upon a first end face 44a, which is formed on the end of the first valve piston 32a facing the outside of the valve housing 34. When an actuating signal is supplied through a non-illustrated signal line to the first proportional magnet 15, the proportional magnet 15 generates upon the end face 44a of the first valve piston 32a an actuating force that displaces the first valve piston 32a to the right in FIG. 2. Thus, the first portion 37a and the second portion 38a are displaced to the right until the second portion 38a interacts in a sealing manner with the bore 33 and hence interrupts the connection between the second annular chamber 35a and the third annular chamber 36.

At the same time, the first portion 37a is displaced into the region of the second annular chamber 35a, so that the corresponding control edge releases a throughflow connection between the first portion 37a and the bore 33. The pressure prevailing in the first supply pressure channel portion 12a is therefore increasingly effective also in the second annular chamber 35a, so that pressure medium flows into the first actuating pressure chamber 6. The rising pressure in the second annular chamber 35a is fed through the first actuating pressure channel 10′ to the first control pressure chamber 42a in the displaceable sleeve 40 and acts there upon the first measuring face 29a. As a result of the rising pressure a hydraulic force is generated, which counteracts the actuating force of the first proportional magnet 15. The first valve piston 32a therefore adopts a position of equilibrium, in which the hydraulic force at the first measuring face 29a jointly with the force of the spring 27 compensates the actuating force of the proportional magnet 15.

As a result of the rising pressure in the first control pressure chamber 42a, the sleeve 40 and the spring 27 are displaced to the right in FIG. 2. A displacement of the sleeve 40 is possible because the axial extent of the sleeve 40 is smaller than the distance between the corresponding seating surfaces 45a, 45b on the first valve piston and the second valve piston 32a, 32b respectively.

The seating surfaces 45a, 45b are provided on a collar formed on the valve piston 32a, 32b. The length of the sleeve 40 is preferably so dimensioned that both valve pistons 32a and 32b may be brought by a force of the proportional magnets 15, 16 into their respective first end position, in which the respective supply pressure channel portions 12a, 12 are connected to the second annular chamber 35a of the first pressure reduction valve 9a and to the second annular chamber 35b of the second pressure reduction valve 9b respectively. The displacement of the sleeve 40 and the spring 27 is effected until a corresponding counter-force is applied up by the second valve piston 32b.

Upon a deflection of the first valve piston 32a by means of an actuating force of the first proportional magnet 15, the spring 27, which is slipped over the sleeve 40 and is freely movable on the sleeve 40, is loaded with a force oriented in the direction of the second valve piston 32b. In the embodiment illustrated in FIG. 2, the spring 27 is supported against the second portion 38a of the first valve piston 32a and against the second portion 38b of the second valve piston 32b. A movement of the first valve piston 32a in the direction of the second valve piston 32b therefore generates an axial force upon the second valve piston 32b, which loads the second valve piston 32b in the direction of the second proportional magnet 16. If the axial force, which is generated by the force of the spring 27 jointly with the hydraulic force at the end face of the extension 39b, upon the second valve piston 32b exceeds the actuating force of the second proportional magnet 16, the second valve piston 32b is brought into and held in its second end position illustrated in FIG. 2.

In order to enable a delayed relief of the second actuating pressure chamber 7, it may however also be provided that first by means of the second proportional magnet 16 an actuating force is exerted upon the second valve piston 32b, so that a connection between the third annular chamber 36 and the second annular chamber 35b of the second pressure reduction valve 9b is still interrupted, while by means of the first pressure reducing valve 9a a pressure is already being built up in the first actuating pressure chamber 6. This has the advantage that the actuating piston 5 is hydraulically clamped at all times during a variation.

Once a sufficiently high pressure has been generated in the actuating pressure chamber 6, the signal for the second proportional magnet 16 is reduced, so that by means of the force of the spring 27 and the hydraulic differential force upon the sleeve 40 the second valve piston 32b is displaced in the direction of the end position illustrated in FIG. 2 and so the second actuating pressure chamber 7 is increasingly relieved.

The above explanations apply equally to a deflection of the control valve unit 9 in the opposite direction.

In FIG. 2 the control valve unit 9 is illustrated in its normal position, in which both proportional magnets 15, 16 receive an imperceptible actuating signal. The length of the spring 27 is so dimensioned that, in the non-energized state of the proportional magnets 15, 16, it loads the first valve piston 32a and the second valve piston 32b with a force so that the two valve pistons 32a, 32b return to the second end position of the pressure reduction valves 9a, 9b that is illustrated in FIG. 2. It is thereby ensured that at all times the valve pistons 32a, 32b are in a defined position. In particular, there is no need to generate a pressure in the control pressure chambers 42a, 42b in order to keep the valve pistons 32a, 32b in contact with the tappets of the proportional magnets 15, 16.

In the illustrated embodiment of FIG. 2, the sleeve 40 is disposed in a freely movable manner on the extensions 39a, 39b. It is equally possible to dispose the sleeve 40 in a fixed manner in the third annular chamber 36, as is shown in FIG. 3. A sleeve 40 disposed in a fixed manner in the third annular chamber 36 has the advantage that, in the event of a pressure increase in one of the control pressure chambers 42a, 42b, there is no need first to fill the enlarging volume in the control pressure chamber 42a and/or 42b. This leads to a more rapid response of the pressure reduction valves 9a, 9b. The fixing of the sleeve 40 may be effected for example by means of an attachment screw 65. The spring 27 may be selected with a pitch that nevertheless allows its axial displacement.

The first annular chamber 31a, 31b of the first pressure reduction valve 9a and/or of the second pressure reduction valve 9b is delimited in the direction of the proportional magnet 15 and/or of the proportional magnet 16 by a region that interacts in a sealing manner with the bore 33. Along this seal a slight leakage flow develops because the first annular chambers 31a, 31b are loaded in each case with the supply pressure. For removal of the leakage fluid, in each case a leakage oil channel portion 46a, 46b is provided, which opens out into a leakage oil bore 46. The leakage oil bore 46 is connected to the relief line 13, so that the leakage fluid that arises may flow off in the direction of the tank volume 14. The leakage oil bore 46 is introduced as a blind hole from one end into the valve housing 34 and sealed by means of a stopper 47.

As has already been explained, the supply pressure channel 12 in the illustrated embodiment of the control valve unit 9 is introduced as a groove in a side wall of the valve housing 34. The groove is closed through abutment with a housing portion of a non-illustrated variation device. In order to keep the valve housing 34 in a defined position relative to the housing portion of the variation device, locating pins 48a, 48b are provided in the valve housing 34. For fixing purposes, threads 49a, 49b are disposed, with which the control valve unit 9 is screw-connected at the variation device 3.

In FIG. 4 a second view of the control valve unit 9 according to the invention is shown. It is evident that from a seating surface 66 of the valve housing 34 a feedback lever 50 projects, on the end of which remote from the valve housing 34 a driving head 51 is formed. With the driving head 51 the feedback lever 50 engages into the actuating piston 5 of the variation device 3. The feedback lever 50 is firmly connected to a shaft 52, wherein the shaft 52 is mounted rotatably in the valve housing 34. Upon an actuating movement of the actuating piston 5, the feedback lever 50 converts the linear actuating movement of the actuating piston 5 into a rotational movement of the shaft 52. The respective angular position of the shaft 52, which corresponds to a specific set volumetric displacement, may be for example be electronically acquired and have an influence upon the determination of the actuating signals for the proportional magnets 15, 16.

FIG. 5 shows the control valve unit 9 according to the invention in a section through the valve housing 34. It is evident that the second annular chambers 35a, 35b are connected by bores through the valve housing 34 to the first actuating pressure line 10 and the second actuating pressure line 11 respectively. The outwardly open bores in the housing 34 are sealed by means of stoppers 54, 55. Also evident is a leadthrough 53, which is used to lead the feedback lever 50 out of the valve housing 34. The oval leadthrough 53 extends in FIG. 5 at right angles to the drawing plane and is connected to the third annular chamber 36. Via the leadthrough 53, therefore, the third annular chamber 36 may be connected to the tank volume 14.

In FIG. 6 an enlarged view of a first embodiment of a valve piston 32a, 32b is shown. As the valve pistons 32a, 32b are of an identical construction, use of the letter suffixes is dispensed with below. On a first end 56 of the valve piston 32 the seating surface 44 is formed. In the region of the first end 56, the diameter of the valve piston 32 corresponds with the bore 33 of the valve housing 34, thereby achieving a sealing effect. The diameter of the first portion 37 and of the second portion 38 likewise corresponds with the diameter of the bore 33. Formed between the first end 56 and the first portion 37 is a region 57 that is reduced in its radial extent, thereby leading to a circumferential groove around the valve piston 32 that jointly with the bore 33 forms the first annular chamber 31a and 31b respectively.

A second region that is reduced in its radial extent is likewise formed between the first portion 37 and the second portion 38. At the side remote from the first end 56 the extension 39 is formed adjacent to the second portion 38. The extension 39 is further reduced in its diameter compared to the reduced region 57 and its end face is designed as measuring face 42, which, when loaded with the discharge-side pressure, generates a force in the opposite direction to the actuating force of the magnet that lies, in terms of magnitude, in the region of the force that may be generated by the magnets. By means of the diameter of the extension 39 it is therefore possible for the hydraulic force acting upon the valve piston 32 to be adapted to the proportional magnets used. At the mutually remote edges of the first portion 37 and the second portion 38 a first control edge 58 and a second control edge 59 are formed. At the first and the second control edge 58, 59, upon displacement of the valve piston 42 in the bore 33, the throughflow connections are produced between the first annular chambers 31a, 31b and the second annular chambers 35a, 35b and/or the second annular chambers 35a, 35b and the third annular chamber 36.

In the sectional view of the valve piston 32, the actuating pressure channel 10′ and/or 11′ may be seen. The actuating pressure channel 10′ and/or 11′ comprises a transverse bore 62 that is disposed in the region between the first portion 37 and the second portion 38. The transverse bore 62 is therefore in permanent communication with the second annular chamber 35 and carries the discharge-side pressure of the reduction valve 9a and/or 9b. In order to feed the pressure carried in the transverse bore 62 to the measuring face 42, there is formed in axial direction in the extension 39 a longitudinal bore 63, which in the illustrated first embodiment of a valve piston 32 in FIG. 6 opens out via a throttle point 64 into the transverse bore 62. By means of the throttle point 64, which takes the form of a bore portion of reduced diameter, the tendency of the pressure reduction valve 9a, 9b to vibrate is reduced. For this purpose, a damping occurs in the throttle point 64 during the pressure equalization and/or the volume equalization of the control pressure chamber 42.

In FIG. 7 a second embodiment of a valve piston 32 is illustrated, which dispenses with the throttle point 64. In addition, on the valve piston 32 of FIG. 7 it is possible to see the seating surface 45, against which the sleeve 40 is supported. The seating surface 45 is formed by a shoulder at the transition from the extension 39 to the second portion 38. The first end 56, the first portion 37 and the second portion 38 are produced preferably by means of a cutting operation, in which by turning the reduced diameters in the region 57 as well as the region between the portions 37 and 38 circumferential grooves are introduced. The region between the portions 37 and 38 as well as the radially reduced region 57 and the collar 60, on which the seating surface 45 is formed, in said case preferably have an identical diameter.

The invention is not limited to the illustrated embodiments. Rather, the individual features of the embodiments may be combined with one another in any desired manner.

1. Control valve unit having a valve element, which is disposed in a longitudinally displaceable manner in a valve housing and is adjustable from a neutral position in the direction of a first end position and an oppositely directed second end position, wherein with increasing adjustment a first output port or a second output port is increasingly connectable to an input port and the respective other one of the two output ports is increasingly connectable to a relief line, wherein
the valve element comprises a first valve piston and a second valve piston, which act upon one another via an elastic element.

2. Control valve unit according to claim 1,
wherein the first valve piston is loadable by a first actuating force in the direction of the second valve piston, and the second valve piston is loadable by a second actuating force in the direction of the first valve piston.

3. Control valve unit according to claim 2,
wherein the elastic element exerts on the first and the second valve piston a force acting in the opposite direction to the first and the second actuating force respectively.

4. Control valve unit according to claim 1,
wherein the first valve piston and the second valve piston have in each case an end face, which is loaded with the pressure of the first output port and the pressure of the second output port respectively.

5. Control valve unit according to claim 4,
wherein the end face is formed on an extension of the first and the second valve piston respectively and the extensions engage into a first control pressure chamber and a second control pressure chamber respectively of a common sleeve.

6. Control valve unit according to claim 5,
wherein the sleeve is disposed in an axially displaceable manner on the extensions.

7. Control valve unit according to claim 5,
wherein the extensions of the first and the second valve piston project in an annular chamber, which is connected to the relief line and in which the sleeve is substantially disposed.

8. Control valve unit according to claim 5,
wherein for supplying the pressure of the first output port and of the second output port to the first control pressure chamber and the second control pressure chamber respectively in the valve pistons in each case an actuating pressure channel is formed.

9. Control valve unit according to claim 1,
wherein the first valve piston and the second valve piston form with the value housing a first pressure reduction valve and a second pressure reduction valve.

10. Control valve unit according to claim 1,
wherein the first valve piston and the second valve piston are of an identical construction and are disposed in opposite directions to one another in a common recess of the valve housing.

11. Control valve unit according to claim 1,
wherein the first and the second valve piston are loadable with an actuating force that is generated in each case by a proportional magnet.

12. Control valve unit according to claim 1,
wherein the first valve piston and the second valve piston are loadable in each case with a hydraulic force.
